(19) United States
(12) Patent Application Publication
(10) Pub. No.: US 2002/0195307 A1
(43) Pub. Date: Dec. 26, 2002

(54) Clutch

(76) Inventors: Max Linhuber, Anger (DE); Patrizia Schnappinger, Anger (DE)

Correspondence Address: Dinnin & Dunn, P.C., Ste. 2100, 755 West Big Beaver, Troy, MI, 48084, US

(21) Appl. No.: 10/179,644

(22) Filed: Jun. 25, 2002

(30) Foreign Application Priority Data
Jun. 25, 2001 (DE) DE 101 30 478.1

(51) Int. Cl. F16D 13/68

(52) U.S. Cl. 192/70.14; 192/70.19

(57) ABSTRACT

A clutch (1) with a multiplicity of clutch discs (5, 6) in the form of friction discs (6) and pressure discs (5), arranged between a clutch basket (2) and a clutch hub (3), and with means of positive torque transmission between the clutch discs (5, 6), the clutch basket (2) and with the clutch hub (3), wherein the means of torque transmission between the clutch hub (3) and the pressure discs (5) are provided by movable driver elements (12).

### BACKGROUND OF THE INVENTION

1. Field of the Invention

The present invention relates to a clutch with a multiplicity of clutch discs in the form of friction discs and pressure discs.

2. Description of the Related Art

The clutch referred to here is therefore a multi-plate clutch with several friction discs and pressure discs, and may be used as an oil bath multi-plate clutch for a motorcycle, between the drive motor and the gearbox of the motorcycle.

A motorcycle clutch of this type usually has a clutch basket, which is connected to the primary drive of the drive motor to transmit the drive torque, and a clutch hub which rests by an internal gearing on the clutch shaft of the motorcycle gearbox. By opening and closing the clutch, the torque transmission from the motor to the gearbox may be interrupted or established.

To simplify mechanical finishing and to reduce the weights to be moved, the clutch hub is usually made from an aluminium alloy and has on its outer periphery a gearing system engaging with pressure discs of the clutch which, for reasons of thermal strength, are made of steel and are also described as steel plates. There is therefore a positive drive torque transmission between the clutch hub and the steel plates, so that on account of the aluminium alloy/steel material pairing, materials with different bearing strengths engage with one another.

For the positive force transmission between the pressure discs and the clutch hub, the steel plates are usually made so as to be wide in the axial longitudinal direction of the clutch hub, in order to ensure that the surface pressure between the external gearing of the clutch hub and the internal gearing of the steel plates assumes low values. This construction sets tight limits for any further reduction in size of the clutch, which are fallen below only by clutches used in racing, in which a short clutch life is taken into account. The fact is that a reduction in the width of the steel plates leads to an increase in the surface pressure between the gearing system partners, and thus to a plastic deformation of the soft aluminium alloy in the form of chatter marks or depressions driven into the external gearing of the clutch hub. These depressions then make it extremely difficult for any movement of the steel plates relative to the clutch hub in the clutch hub axial direction, so that the clutch no longer opens properly and therefore no longer separates cleanly. In a clutch worn in this way, it is necessary to replace at least the clutch hub by a new one.

### SUMMARY OF THE INVENTION

To remove the drawbacks described above, the present invention is based on the problem of creating a clutch in which it is possible to reduce the width of the steel plates and thus the overall space required by the clutch, without the risk of premature damage to the clutch.

To solve this problem, the invention has the features specified in claim 1.Advantageous developments of these are described in the additional claims.

According to the invention a clutch is now provided with a multiplicity of clutch discs in the form of friction discs and pressure discs, arranged between a clutch basket and a clutch hub, and with means of positive torque transmission between the clutch discs and the clutch basket together with the clutch hub, wherein the means of torque transmission between the clutch hub and the pressure discs are provided by movable driver elements.

This means, in other words, that a torque transmission takes place between the clutch hub and the pressure discs via interposed movable driver elements, against which the clutch hub and the pressure discs rest. At the same time these driver elements may be so designed that they increase the effective surface for positive torque transmission between themselves and the clutch hub, thereby reducing the surface pressure occurring at the clutch hub, so that the steel plates may be made smaller (narrower), resulting in an overall reduction in the axial length of the clutch.

To reduce the width of the steel plates, therefore, the critical factor is now the acceptable surface pressure occurring between the steel plates and the movable driver elements, since the effective force transmission surface between the driver elements and the clutch hub is increased on account of the driver elements.

According to a further development of the invention it is here provided that the driver elements are tubular. bodies, mounted so as to be capable of sliding in the direction of the longitudinal axis of the clutch hub. With this design, when the clutch is opened and/or closed, the driver elements are able to move relative to the clutch hub and/or the pressure discs in such a way that, on the one hand, an optimal contact pattern for the particular conditions is established between the force transmission partners, while on the other hand the ability to modulate the clutch is distinctly improved as compared with known clutches.

According to an advantageous embodiment, the clutch hub has a hub with circular-segment-shaped recesses complementary to the driver elements on its outer periphery. The driver elements engage in these recesses. Therefore, on opening and/or closing of the clutch, the driver elements execute small longitudinal movements in the circular-segment-shaped recesses, which match the outer peripheral shape of the tubular elements. The driver elements are also able to rotate around their respective vertical axes, so that there are no coefficients of friction between the force transmission partners to restrict clutch modulation.

At the same time the driver elements may be arranged on the clutch hub at substantially equal angular intervals, and specifically in a number corresponding to the level of the drive torque of the motor which is to be transmitted. Here the pressure discs already referred to above are annular bodies, with recesses on their inner periphery which are complementary to the outer peripheral shape of the driver elements. Consequently a positive torque transmission is possible between the pressure discs, the driver elements and the clutch hub, and the driver elements are able to move relative to the pressure discs, viewed in the axial longitudinal direction of the clutch hub.

The clutch hub provided according to the invention may be made from a weight-saving light metal alloy. On its outer periphery side it has circular-segment-shaped recesses running in the axial longitudinal direction of the clutch hub, into which the driver elements—made for example of steel—may be inserted. These elements have a diameter such that the surface pressure values prevailing between the clutch hub and the driver elements are not critical. The pressure discs of the clutch provided according to the invention may also be made of steel or a steel alloy and are not in direct physical connection with the clutch hub, but instead lie only on the driver elements. Consequently, on account of the steel-on-steel material pairing which then exists, narrow or thin pressure discs are possible so that the clutch may be made short, viewed in its axial longitudinal direction. This short construction also leads to a reduction in the rotational moment of inertia of the clutch, therefore leading altogether to an internal combustion engine design which reacts very willingly. The clutch provided according to the invention also stands out for the fact that, compared with known clutches, its wearing behaviour is very much more favourable. Also, owing to the wide surfaces available for torque transmission between the clutch hub and the driver elements, good damping is obtained, the modulation of the clutch noticeable for the driver of the motorcycle thus equipped is markedly enhanced, since chatter marks or the like no longer occur, and in addition machining of the clutch basket is simplified since the extension angles required on known clutches between the clutch hub and the steel plates are dispensed with.

### BRIEF DESCRIPTION OF THE DRAWINGS

The invention is described in detail below with the aid of the drawing, which shows in:

FIG. 1 a perspective exploded view of a clutch according to the invention; and

FIG. 2 a perspective view of clutch discs mounted on the clutch hub, with driver elements in engagement with the hub and the pressure discs.

### DESCRIPTION OF THE EMBODIMENT(S)

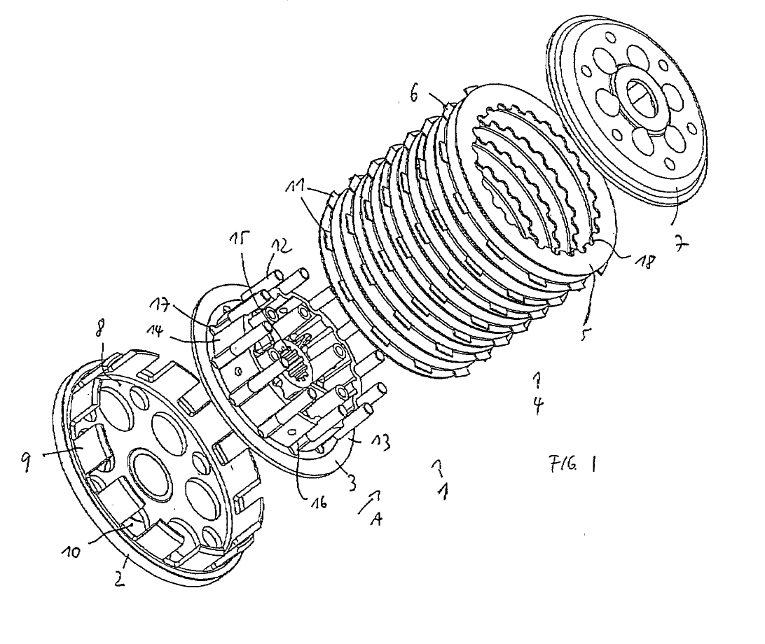

FIG. 1 of the drawing shows in a perspective exploded view an embodiment of a clutch according to the present invention in which, to simplify the illustration, known components such as for example clutch compression springs, spring retaining screws, the clutch push rod and the like have been omitted.

The clutch 1 according to the present invention has a clutch basket 2 which is designed to accommodate a clutch hub 3, on which a clutch disc assembly of clutch discs 4 in the form of pressure discs 5 and friction discs 6 may be assembled. A pressure plate 7 is placed on top of the clutch disc assembly and presses on the disc assembly by means of clutch compression springs, which are not illustrated, in order to generate frictional resistance between the individual discs.

In a manner not shown in detail, the clutch basket 2 may be connected to the primary drive of a drive motor, in the form for example of a motorcycle engine, to supply to the clutch basket 2 an output torque originating from the engine. The clutch basket 2 has an altogether cup-shaped configuration with a base 8, with integral clutch basket tongues extending upwards away from the base 8. Between the clutch basket tongues 9 are interspaces 10 in which the plates 11 of the friction discs 6 can engage, so that the output torque originating from the engine can be transferred via the clutch basket tongues to the plates 11 of the friction discs 6 and then, via the frictional resistance between the friction discs 6 and the pressure discs 5 to the clutch hub 3 and specifically via the driver elements 12, which will be explained in more detail below.

The clutch hub 3 has a disc-shaped base 13 with an outer diameter such that it can be accommodated within the clutch basket tongues 9. Integrally formed on the base 13, radial somewhat inwards, is a top part 14 which serves to transfer the torque introduced via the driver elements 12 to the internal gearing 15 which is also an integral part of the base 13.

As is clearly apparent, the top part 14 extends from the base or underside 13 of the clutch basket at a right-angle and has distributed at equal angular intervals on its outer periphery circular-segment-shaped recesses 16, which are designed to be complementary in surface and shape to the outer surface and form of the driver elements 12. At the same time, each of the recesses 16 has in the transition zone towards the base 13 of the clutch hub 3 a centring recess 17, the diameter of which corresponds substantially to the external diameter of the driver elements 12, so that the driver elements may be held in these centring recesses.

The driver elements 12 have a tubular shaped configuration and are preferably made of a steel alloy. They are held in the recesses 16, which in cross-section are circular-segment-shaped, with the ability to slide longitudinally in the direction of arrow A, and are each able to rotate around their own axes in the recesses 16 and 17 respectively, so that an optimal contact pattern for torque transmission may be established.

The clutch disc assembly 4 is comprised of a multiplicity of pressure discs 5 and friction discs 6 stacked alternately on top of one another, and which may be fitted on the top part 14 of the clutch hub 3 and inside the clutch basket 2 respectively. The pressure discs 5 are annular disc-shaped bodies with an internal gearing which is complementary in shape and surface to the driver elements 12. If now the clutch disc assembly 4 is mounted on the top part 14 of the clutch hub 3, then a positive connection is made between the driver elements 12 and the internal gearing 18 of the pressure discs 5, thus making torque transmission possible. When the clutch 1 is operated, i.e. during opening and closing of the clutch 1, slight sliding movements in the direction of arrow A occur within the clutch disc assembly 4, so that a relative movement takes place between the driver elements 12 and the pressure discs 5, and between the driver elements 12 and the recesses 16. During this relative movement the driver elements 12 are also able to rotate around their own vertical axes, thereby allowing stress-free movement of the driver elements 12 and resulting on the one hand in an optimal contact pattern within the gearing system, and on the other hand in a distinct improvement in modulation of the clutch.

The pressure discs 5 may be made for example of a steel alloy, resulting in a force transmission virtually without wear between the pressure discs and the driver elements 12 which are also made of a steel alloy. The forces thus introduced are transferred via the driver elements 12 to the recesses 16 of the clutch hub 3 which are equipped with wide effective force transmission surfaces. Since this torque transmission, unlike that of known clutches, does not involve a torque transmission between the pressure discs 5 and the clutch hub 3 based on direct positive contact, the risk of formation of chatter marks and the like, which may necessitate complete replacement of the clutch hub 3 and/or the pressure discs 5, is avoided. Even in the case of a compact clutch according to the invention intended for racing use, pressure discs 5 or driver elements 12 which become worn are easily replaced since, after loosening the pressure plate 7, they are accessible from the outside, so that it is not necessary to replace the clutch hub 3 in the event of wear, as was the case previously.

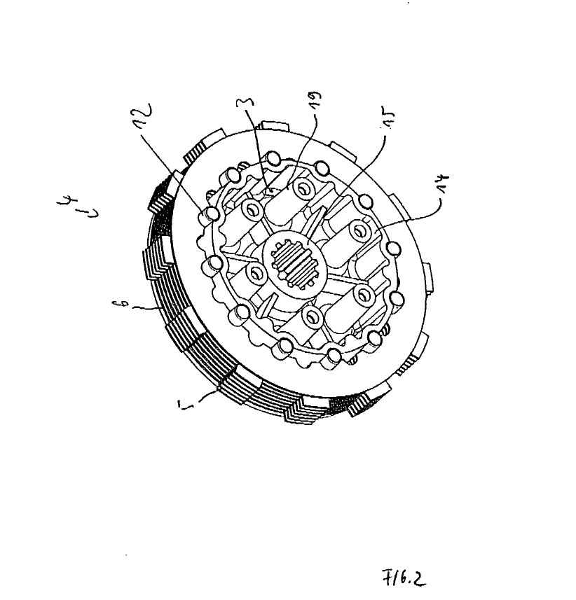

FIG. 2 of the drawing shows a perspective view of driver elements 12 together with pressure discs 5 and friction discs 6 fitted on to the top part 14 of the clutch hub 3. In this embodiment twelve driver elements 12 are provided, although it is possible to vary the number of driver elements depending on the drive motor torque to be transmitted. The torque thus initiated into the clutch hub 3 may be fed via the internal gearing 15 to a clutch shaft, not shown in detail. Here the torque transmission takes place through frictional connection within the clutch disc assembly 4, with the normal force required to generate frictional force being produced within the clutch disc assembly 4 via clutch coil springs mounted on retainers 19. Due to the driver elements 12 made of steel fitted to the clutch hub 3 it is possible to allow the steel plates and pressure discs 5 respectively to lie upon a wear-resistant driver elements surface. The driver elements 12 may be removed without having to remove the clutch disc assembly 4. Due to the scope for movement of the driver elements 12 not only in the axial longitudinal direction of the top part 14 but also around their vertical axis, the positive connection thus created has a uniform contact pattern. Since with this variant of the clutch hub 3 according to the invention no stress peaks occur, as happens with the positive engagement of the steel plates on the clutch hub of a known clutch, the wall thickness of the top part 14 may be reduced, thereby reducing the weight of the clutch and also the rotational moment of inertia. On account of the steel-on-steel material pairing between the pressure discs 5 and the driver elements 12 it is possible to reduce the thickness of the pressure discs 5 measured in the direction of arrow A (FIG. 1), thereby creating an exceptionally lightweight and compact clutch. Because of the broad effective contact surfaces between the driver elements 12 and the recesses 16 of the clutch hub 3, wear of the clutch hub 3 is considerably reduced, so that a longer clutch life may be assumed.

With regard to features of the invention not explained in details above, express reference is made to the claims and the drawing.

What is claimed is:

1. A clutch with a multiplicity of clutch discs in the form of friction discs and pressure discs, arranged between a clutch basket and a clutch hub, and with means of positive torque transmission between the clutch discs, the clutch basket and the clutch hub, wherein the means of torque transmission between the clutch hub and the pressure discs are provided by movable driver elements.

2. The clutch according to claim 1, characterised in that the driver elements are slidably mounted in the direction of the longitudinal axis of the clutch hub.

3. The clutch according to claim 1, characterised in that the driver elements are tubular bodies.

4. The clutch according to claim 1, characterised in that the clutch hub has a top part with circular-segment-shaped recesses complementary formed to the driver elements on the outer periphery, into which the driver elements are inserted.

5. The clutch according to claim 1, characterised in that the driver elements are arranged on the clutch hub at substantially equal angular intervals.

6. The clutch according to claim 1, characterised in that the pressure discs are annular bodies with a gearing on their inner periphery which is complementary to the driver elements.

7. The clutch according to claim 1, characterised in that when the clutch is opened and/or closed the driver elements execute a longitudinal movement and/or a rotary movement relative to the recesses of the clutch hub and/or the gearing of the pressure discs.

8. The clutch according to claim 1, characterised in that the driver elements and the pressure discs are made of steel.

9. The clutch according to claim 1 for use as a multi-plate wet clutch of a motorcycle.

10. A method of using the clutch according to claim 1 as a multi-plate wet clutch of a motorcycle.
